(19) United States
(12) Patent Application Publication
(10) Pub. No.: US 2007/0291177 A1
(43) Pub. Date: Dec. 20, 2007

(54) SYSTEM, METHOD AND COMPUTER PROGRAM PRODUCT FOR PROVIDING REFERENCE LINES ON A VIEWFINDER

(75) Inventors: Jose Lahoz, Salo (FI); Gurutzeta Guillera, Salo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/425,292

(22) Filed: Jun. 20, 2006

(51) Int. Cl. H04N 5/14; H04N 5/225

(52) U.S. Cl. 348/571; 348/207.99

(57) ABSTRACT

Systems, methods, and computer program products are provided for presenting at least one reference line on an electronic viewfinder. The system generally comprises an image capturing device and an electronic display; both operatively coupled to a processor. The processor may be configured to receive image data from the image capturing means and display that data on the electronic display so that the electronic display operates as an electronic viewfinder. The processor can be configured to also display one or more reference lines overlaying the image displayed on the viewfinder. The reference lines may be alterable by the user so that the user can better use the reference lines to help the user properly position the image capturing device when the user is capturing or preparing to capture an image.

### FIELD OF THE INVENTION

Embodiments of the invention generally relate to systems and methods for providing reference lines on a camera's viewfinder and, more particularly, relate to systems and methods for providing user-alterable reference lines on an electronic viewfinder where the reference lines are configured to guide the user when positioning a camera.

### BACKGROUND OF THE INVENTION

Human vision can be very sensitive to the position of straight lines. In a photograph, even a very small tilt of a straight line that should be parallel to the picture border is easily noticed by our vision system. For example, FIG. 1 shows an image 10 of a seascape. The seascape comprises a horizon 12 where the sea and the sky meet. Since the human mind understands that the horizon 12 should be perfectly horizontal, the user must be careful to keep the camera perfectly horizontal when taking the picture. If the camera is rotated even slightly in the clockwise or counterclockwise direction, the image may appear tilted. In practice, an image generally appears tilted if an object or feature of the image that should be horizontal or vertical is not parallel to whatever the human mind uses as a horizontal or vertical reference. For example, for images that are printed and displayed in a standard rectangular format, a person viewing the image will generally view a horizon in the image as being “horizontal” if the horizon is parallel to the top and bottom borders or edges of the image. If the images are displayed on an electronic display, monitor, or television, the horizon will generally appear horizontal if it is parallel to the image border or the edge of the screen or display.

The image 10 of FIG. 1 is a representation of an image of a seascape where the image 10 was taken with the camera rotated slightly in a clockwise direction so that the horizon was not perfectly horizontal when taking the picture. Lines 14 have been included here to show the degree by which the horizon is tilted from the horizontal. As can be seen from FIG. 1, even a small degree of tilt can be perceptible to the human eye. Such a perceivable tilt, when unintended, will generally subtract from the aesthetic value of the picture.

The tilt in the image would be more noticeable if the picture was viewed or printed in a larger size. For example, if the image were to be blown-up for hanging on a wall or if the image were to be viewed on a computer monitor or television, the tilt may be more easily perceived. Conversely, small tilts in an image may be especially difficult to perceive on small electronic viewfinders.

In this regard, capturing an image that is exactly horizontal can be particularly difficult if the camera's viewfinder is small. The use of small viewfinders is becoming more prevalent since many digital cameras are specifically designed to be small enough to easily fit in the user's pocket. Furthermore, cameras are increasingly included as a feature on other electronic devices, such as mobile telephones and personal digital assistants (PDAs). Since these devices are also often specifically designed to be small, the electronic displays that serve as the viewfinder for the camera may only measure one or two square inches. These small displays make it increasingly difficult for the user to perceive tilts in the displayed image when taking a picture, even though these tilts become both noticeable and aesthetically unappealing when the image is subsequently enlarged.

Similar problems can exist when taking pictures of objects having lines that are intended to be vertical. For example, pictures of city skylines, towers, buildings, walls inside a room, etc., will not be as aesthetically pleasing if such features that are actually vertical do not appear to be vertical since they are not parallel to the side “vertical” borders of the image.

Current solutions to these problems generally involve post-processing of the image to correct any tilt in the image. For example, a user might be able to use image post-processing software to correct any perceptible tilt in the image. Such software may be equipped with an angle correction tool capable of correcting the tilt in an image by rotating the digital image and cropping the image so that the final borders are parallel with the desired horizontal or vertical features in the image. Digitally modifying the image in this way may, however, cause a reduction in the original resolution of the image and a loss of area. Specifically, since the original image must be cropped, some of the image content around the borders will be lost. Furthermore, the modified picture will have fewer pixels and will be smaller than the standard image size. In addition to these undesirable effects, many users may not have post-processing software equipped with an angle correction tool. Furthermore, a user might not have or desire to spend the time to fix each image using this method. Even if the user did have such software for use with still photographs, it is unlikely that the average user would own software capable of correcting tilt in a video recording.

Attempting to post-process an image recorded on film in order to correct tilt poses additional problems. In this regard, post-processing an image recorded on film would involve the additional step of scanning a developed image, thereby increasing the processing time and further degrading the quality of the image. Accordingly, in most cases it would not be practical to use software to correct the tilt in an image recorded on film media.

As an alternative to using software to rotate and crop an image, the user may be able to rotate and crop the image by hand. For example, the user could print or develop the picture and then cut the edges of the picture so that they are parallel with a horizontal or vertical feature of the image. If the user is matting and framing the picture, the user could rotate the image accordingly and mount it under the mat at the rotated angle. In either case, correcting the tilt by hand would require a substantial amount of work and time, and the process would have to be repeated each time the user prints an image. The resulting image would also be smaller than the original image and some of the image content at the borders would be lost. Furthermore, it would not be possible to rotate and crop a video image or a digital image by hand.

Therefore, a solution is needed to avoid or at least reduce tilt in a picture. Preferably, the solution would assist in correctly positioning the camera when the picture is being taken so that post-processing would not be necessary to fix problems in the image that were the result of a poorly aligned camera. Advantageously, tilt could be reduced while maintaining the original size and resolution of the image. It would also be advantageous if tilt could be reduced in video recordings, as well as still images.

### BRIEF SUMMARY OF THE INVENTION

A system, method, computer program product, and apparatus are therefore provided for guiding a user to correctly position an image capturing device when capturing an image. In particular, embodiments of the present invention relate to providing reference lines on the viewfinder of an image capturing device so that the user can align a feature in the image with the reference line.

In one exemplary embodiment of the present invention, a system includes an image capturing device configured to capture an image, a display for viewing a representation of the image; and a processor configured to present a reference line on the display along with the representation of the image. The processor is further configured to be responsive to user input in order to alter a position of the reference line with respect to the display. The image capturing device, the display and the processor may be embodied in a mobile telephone or digital camera. The image capturing device may be configured to record a video image or a still image.

In one embodiment, the display may comprise a plurality of pixels, organized in generally parallel rows, and the processor is configured to illuminate at least one row of pixels to present the reference line. The processor may be configured to present a horizontal reference line, a vertical reference line, or a reference line at some other angle relative to the display. The processor may be configured to present a solid line, a dashed line, a semi-transparent line displayed over the representation of the image.

In one embodiment, the processor is configured to present a reference line comprised of a first line segment extending from a first side of the display only partially across the display, and a second line segment extending from a second opposing side of the display only partially across the display, wherein the first and the second line segments are linearly aligned with each other. In one embodiment, where the border of the image captured by the image capturing device comprises a straight portion, the processor may be configured to present a reference line that is parallel to the straight portion of the border of the image.

In one embodiment, the system also includes a user input device. The user input device may be configured to allow a user to selectively activate and deactivate presentation of the reference line. The user input device may be configured to allow a user to alter an angle of the reference line with respect to the display. The user input device may be configured to allow a user to alter a location of the reference line on the display. The user input device may include a directional key for moving the reference line relative to the display so that the reference line moves in a direction perpendicular to itself while maintaining a consistent angle relative to the display. The user input device may be configured to allow a user to alter characteristics of the reference line.

In one embodiment, the reference line is at a first altered position when a first image is recorded, and the processor is configured to initially set the position of the reference line to the first altered position in preparation for recording a second image.

In another exemplary embodiment, a method of taking a picture is provided including the steps of: providing an electronic device having a camera, wherein the camera includes an electronic viewfinder for viewing a representation of an image to be recorded by the camera, and wherein the electronic viewfinder is configured to display a reference line overlaying the representation of the image; altering the position or orientation of the reference line relative to the electronic viewfinder; altering the position or orientation of the camera so that a feature in the representation of the image is aligned with the reference line; and recording the image.

In one embodiment of the method the reference line has a predefined orientation, and the altering step further includes the steps of: identifying an object or feature in the image to be recorded having the same predefined orientation; moving the reference line relative to the viewfinder so that the reference line is positioned closer to the identified object or feature; and altering the position or orientation of the camera so that the identified object or feature is generally parallel to the reference line.

In another embodiment, the altering step includes the steps of: moving the reference line to a first altered position on the viewfinder proximate to an object or feature in a first image and recording the first image; and positioning the camera so that the same object or feature is positioned proximate the reference line in the first altered position, and recording a second image.

In another exemplary embodiment of the present invention, a computer program product is provided for facilitating positioning of a camera, wherein the camera is operatively coupled to an electronic display configured to be used as a viewfinder for the camera. The computer program product includes at least one computer-readable storage medium having computer-readable program code portions stored therein. The computer-readable program code portions include: a first executable portion for displaying a reference line on the electronic viewfinder; and a second executable for altering the position or the orientation of the reference line relative to the electronic viewfinder in response to instructions received from the user.

In one embodiment of the computer program product, the electronic viewfinder displays images as generally parallel rows of pixels, and the first executable portion is configured to instruct the electronic viewfinder to display the reference line with one or more rows of pixels. In another embodiment of the computer program product, the computer-readable program code portions further includes a third executable for altering the color, transparency, line type, or line width of the reference line in response to instructions received from the user.

In another exemplary embodiment of the present invention, an apparatus is provided having a display for viewing an image, and a processing element configured to present a reference line on the display along with the image. The processor is further configured to be responsive to user input in order to alter a position of the reference line with respect to the display. In one embodiment, where the border of the display comprises a straight portion, the processing element is configured to present a reference line that is parallel to the straight portion of the border of the display. In another embodiment, the processor is configured to be responsive to user input in order to alter a characteristic of the reference line. Furthermore, in some embodiments, the apparatus may includes an image capturing device for capturing the image viewed on the display.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts an image having a small degree of tilt in the clockwise direction;

FIG. 2 is a schematic block diagram of a system or device that would benefit from one exemplary embodiment of the present invention;

FIG. 3 depicts a display view with a horizontal reference line activated in accordance with one embodiment of the present invention;

FIG. 4 depicts a display view with the horizontal reference line moved by the user close to the horizon in accordance with one embodiment of the present invention;

FIG. 5 depicts the display view with the angle of tilt corrected by lining up the horizon with the horizontal reference line in accordance with one embodiment of the present invention;

FIG. 6 depicts the resulting recorded image with little or no tilt; and

FIG. 7 is a schematic block diagram of a mobile terminal according to an exemplary embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present invention relate to systems, methods, devices, and computer program products for guiding a user to correctly position an image capturing device when capturing an image. In particular, embodiments of the present invention relate to providing reference lines on the viewfinder of an image capturing device.

The system, method, and computer program product of exemplary embodiments of the present invention will be primarily described without respect to the environment within which the system, method, and computer program product operate. It should be understood, however, that the system, method and computer program product may operate in a number of different environments, including mobile and/or fixed environments, wired and/or wireless environments, standalone and/or networked environments or the like. For example, the system, method, and computer program product of exemplary embodiments of the present invention can operate in mobile communication environments whereby mobile terminals operating within one or more mobile networks include or are otherwise in communication with one or more image capturing devices.

FIG. 2 provides a block diagram of a system that would benefit from embodiments of the present invention. As shown, the system includes various means for performing one or more functions in accordance with exemplary embodiments of the present invention, including those more particularly described herein. It should be understood, however, that the system may include alternative means for performing one or more like functions, without departing from the spirit and scope of the present invention. More particularly, for example, as shown in FIG. 2, the system can include a processor 20 operatively connected to a memory system 22. The memory system can comprise volatile and/or non-volatile memory, and typically stores content, data or the like. For example, the memory system can store client applications, instructions, or the like for the processor to perform steps associated with operation of the entity in accordance with exemplary embodiments of the present invention. Also, for example, the memory system can be configured to store one or more images or video sequences, such as those received from the image capturing system 24.

As described herein, the client application(s), instructions, or the like may comprise software operated by the processor 20. It should be understood, however, that any one or more of the client applications described herein can alternatively comprise firmware or hardware, without departing from the spirit and scope of the present invention. Generally, then, the processing element can include one or more logic elements for performing various functions of one or more client application(s), instructions, or the like. As will be appreciated, the logic elements can be embodied in any of a number of different manners. In this regard, the logic elements performing the functions of one or more client applications, instructions, or the like can be embodied in an integrated circuit assembly including one or more integrated circuits integral or otherwise in communication with the processor 20. The design of integrated circuits is by and large a highly automated process. In this regard, complex and powerful software tools are available for converting a logic level design into a semiconductor circuit design ready to be etched and formed on a semiconductor substrate. These software tools automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility.

In addition to the memory system 22, the processor 20 can also be operatively connected to at least one interface or other means for displaying, transmitting and/or receiving data, content, or the like. In this regard, the interface(s) can include at least one user interface that can include a display system 26 and/or a user input system 28. In some embodiments the user interface may comprise other systems, such as a speaker system. The user input system 28 can comprise any of a number of devices allowing the entity to receive data from a user, such as a microphone, a voice recognition system, a keypad, a touch display, a joystick, or other input device. In addition to the user interface(s), the interface(s) can also include at least one communication interface (not shown) or other means for transmitting and/or receiving data, content, or the like, from external systems.

The processor can also be operatively connected to an image capturing system 24 such as a system comprising a conventional film camera, a digital camera, a video camera, an image sensor, or other image capturing means.

It should be understood that in some embodiments, the systems described above or illustrated by FIG. 2 can be supported by a single entity or by separate entities. The systems may be located in different entities but operatively coupled so that they may communicate with the processor system 20. Such communication can be coupled via a wired connection, a wireless connection, and/or over a network. Alternatively, the systems can be co-located within the respective entity but be logically separated. For example, a mobile terminal may support a logically separate, but co-located, image capturing system and processing system. Irrespective of the manner of implementing the system, however, the image capturing system can comprise any of a number of different entities capable of capturing one or more images. Similarly, the processor can comprise any of a number of different entities capable of processing an image received from the image capturing system to automatically generate a representation of the image to be displayed to the user on the display system or to store the image in the memory system when instructed to do so based upon information received from the user input system.

An exemplary embodiment of the invention will now be described with reference to FIGS. 2-6. Embodiments of the present invention may be employed, for example, in the system of FIG. 2. It should be noted, however, that embodiments of the present invention may be employed in a variety of other more or less complex systems or devices.

Embodiments of the present invention provide a system, method, device, or computer program product configured to help a user position an image capturing device as desired by the user when capturing an image or when preparing to capture an image. In one embodiment of the present invention, the image capturing system 24 comprises a camera, and the display system 26 comprises an electronic display configured to be used as a viewfinder for the camera. As described above, in some systems, these elements may be located separately and even in different devices. In such embodiments, the elements may be operatively coupled to the processing system by a wired means, a wireless means, or by some combination of the two. In one embodiment, the camera may be located remotely from the electronic display and coupled to the electronic display via a network, such as a local area network, a wide area network, such as the internet, or the like.

When the electronic display is being used as an electronic viewfinder, the system is typically configured to display a representation of the image that would be recorded by the image capturing system at that moment in time. For example, the user of a camera-equipped device can look at the electronic viewfinder in order to see where the camera lens, sensor, or other optical sensing means is directed. Specifically, by looking at the electronic viewfinder, the user can see what image will be captured by the optical sensing means. Thus the electronic viewfinder allows the user of the camera-equipped device to attempt to position the camera in such a way as to capture the image that the user desires to record.

In the case of a camera-equipped device configured to record still images, the user can adjust the camera module while looking at the electronic viewfinder. Once the user positions the camera module so that a representation of the desired image is displayed on the electronic viewfinder, the user can then actuate a user input device to instruct the camera-equipped device to record the picture. In the case of a camera-equipped device configured to record video images, the electronic viewfinder may not only be configured to display a representation of the image to be recorded, but may also be used to show the user a representation of the image actually being recorded at that time by the camera-equipped device if the camera-equipped device is in the video recording mode.

In embodiments where the image capturing system comprises a digital camera, the image sensor can be used both to capture the image to be recorded and to capture the image to be displayed on the electronic viewfinder. However, where the image capturing system comprises a film-based camera, the image capturing system may further comprise an image sensor, such as a CCD or a CMOS image sensor, for capturing the image to display on an electronic viewfinder, in addition to the typical image capturing means of a conventional film-based camera.

The electronic viewfinder of the present invention may be comprised of any type of electronic display. For example, the electronic display could be comprised of a liquid crystal display (LCD), a cathode ray tube (CRT) based display, a light-emitting diode (LED) based display, an organic LED (OLED) based display, a plasma-based display, a DLP-based display, or various other types of electronic displays.

Embodiments of the present invention may be embodied in various types of electronic devices. For example, the electronic device may be a camera-equipped telephone, mobile telephone, personal digital assistant (PDA) device, laptop computer, digital camera, camcorder, or any device capable of having a camera and an electronic viewfinder. Alternatively, as described above, the camera and the electronic viewfinder may be parts of separate electronic devices. In this alternative embodiment, the electronic viewfinder and the camera may communicate via a wired connection or a wireless connection. For example, the camera may be wired to a television or other monitor for using the television or monitor as a viewfinder for the camera. In another embodiment, the position of the camera may be adjustable by a remote control, and the electronic display may be connected to the camera wirelessly or over a network, so that the user may be located remotely from the camera. For example, the camera may comprise a remote-controlled webcam or a camera attached to a remote controlled vehicle, and the electronic viewfinder may comprise a computer screen located elsewhere and in communication with the camera, such as via a network.

In exemplary embodiments, the camera-equipped electronic device is a handheld digital camera, a video camera, a camera-equipped mobile telephone, or a camera-equipped PDA. Note, however, that the camera need not be a digital camera and could be a camera configured to record an image on film or by some other means. If the camera has an electronic viewfinder, the reference lines constructed in accordance with the embodiments of the present invention may be displayed on the viewfinder regardless of the medium on which the image is recorded.

Although not limited to handheld camera-equipped devices, as described above, the reference lines constructed in accordance with embodiments of the invention may be particularly advantageous to such devices since the displays are often small making it more difficult to perfectly position the image in the display when taking a picture. Furthermore, the user may be holding the handheld device at arms length so as to take a picture over a crowd or around a corner. Used in this way, the user may be standing at an angle to and at a distance from the display making it even more difficult for the user to view the exact orientation of the camera or of the image displayed on the display. Finally, many small handheld devices are incapable of being used on a tripod, or are employed by a user who does not own a tripod or will not use a tripod often. Similarly, many of the small handheld devices are designed to be carried in a pocket so that the user can take a picture whenever the situation arises. As a result, the user will often not have a tripod or any other device on hand that will help the user correctly position the camera. Thus, the reference line system and method of embodiments of the present invention may be particularly useful when incorporated into a camera-equipped handheld device, since the system can be configured to be an easy to use software feature of the handheld device that is always available and that does not add any size to the device but provides the user with a means for helping the user to properly align the camera.

In sum, embodiments of the present invention are not limited to a particular camera technology, camera-equipped device, or display type. Instead, embodiments of the present invention are more generally directed to a system, method, and computer program product for displaying reference lines on an electronic viewfinder.

In an exemplary embodiment of the present invention, the reference line is a reference line configured to represent a horizontal line overlaying or otherwise superimposed upon the image displayed in the electronic viewfinder. In practice, where the reference line is configured to represent a “horizontal line,” the line will generally be a line representing a line that is parallel to the image borders in the recorded image format that are intended to represent the horizontal (e.g., where the recorded image format is the typical rectangular format). Although it is generally advantageous that the horizontal reference line be configured to accurately represent a line that would be parallel to the borders of the recorded image, it may sometimes be easier to create a horizontal reference line by creating a line on a display that is parallel to the display's borders. In such an embodiment, where the reference line is configured to be parallel to the display borders, the display is typically configured so that the display borders were generally parallel to the borders of the recorded image. In an embodiment in which the display image is comprised or rows of pixels, the reference line may be comprised of one or more rows of pixels extending across the display. It should be understood from this description that the “horizontal” reference line displayed on the electronic viewfinder may not be horizontal itself relative to the gravitational field if the electronic viewfinder is not truly horizontal, such as, for example, if the camera-equipped device is turned on its side. For example, a user of a conventional digital camera that records rectangular images where the width of the recorded image is greater than the height may rotate the camera ninety degrees in a clockwise or counterclockwise direction in order to take a picture where the height of the image is greater than the width (i.e. a “portrait” format instead of a “landscape” format). In such a situation, a reference line that was configured to be used as a horizontal reference line in the landscape format may now be used as a vertical reference line in the portrait format. Furthermore, other reference lines may in fact be used, such as a true “vertical” reference line or a reference line oriented in some other predefined manner.

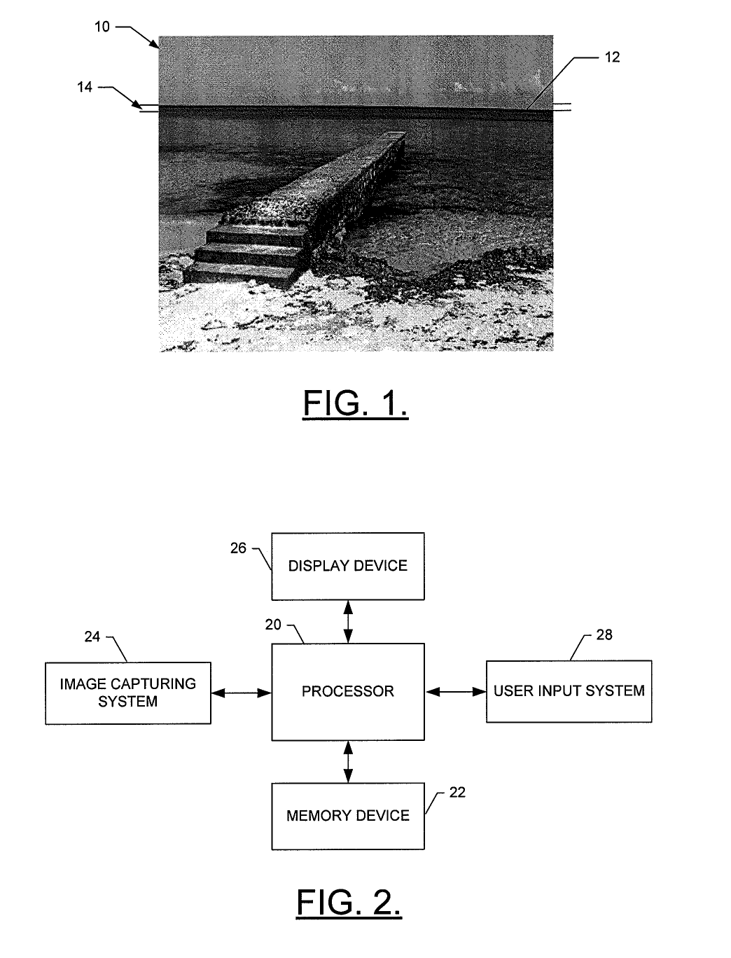

Using the method described below, a horizontal reference line constructed in accordance with embodiments of the present invention may be useful to address the problem of photographing tilted images that was discussed above. As described earlier, FIG. 1 shows an image 10 of a seascape, the image comprising a horizon 12 where the sea and the sky come together in the image 10. The markings 14 on the opposite sides of the image in FIG. 1 are provided herein for discussion purposes and show that the horizon 12 is not “horizontal.” In other words, the horizon 12 is not exactly parallel to the top and bottom image borders. As a result, the image appears tilted. The horizon may appear tilted as in FIG. 1 if the camera was rotated even a small degree in the counter-clockwise direction. This would cause the recorded image or the image displayed by the electronic viewfinder to appear to be rotated in the clockwise direction relative to the image borders. It should be noted that FIG. 1 may represent an image displayed by a viewfinder where the electronic device or the camera module itself is not held perfectly horizontal. FIG. 1 may also represent a photograph that was taken with the device or camera module not perfectly horizontal.

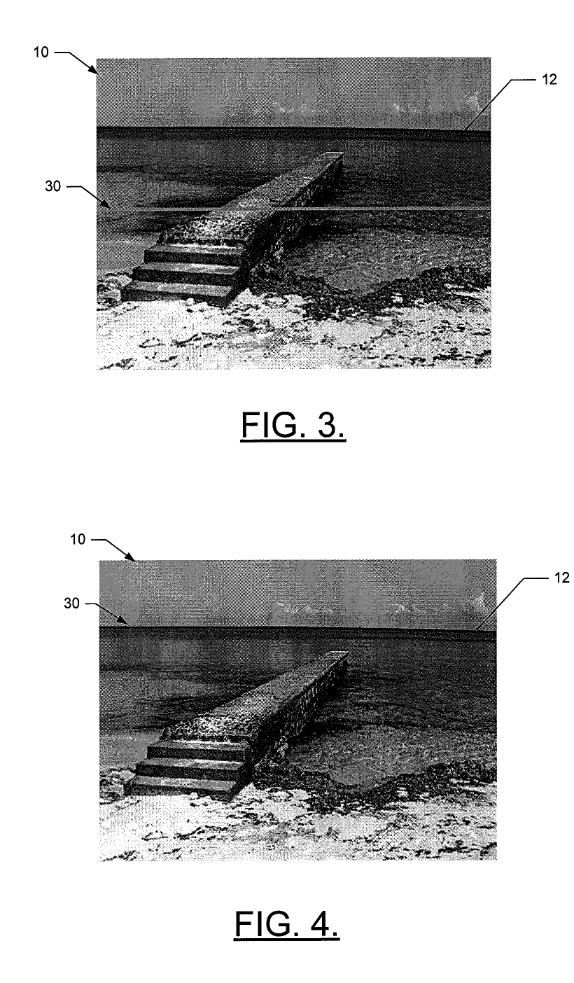

FIG. 3 depicts a view of an image 10 as might be displayed by an electronic viewfinder consistent with one embodiment of the present invention. Image 10 is the image displayed by the electronic viewfinder and is also a representation of the image that would be captured by the camera. The image to be captured is similar to the image of FIG. 1 wherein the image comprises a horizon 12 that the user intends to appear horizontal (i.e., parallel to the top and/or bottom image borders) in the resulting captured image. FIG. 3 further depicts an exemplary embodiment of a reference line 30.

The reference line 30 is depicted in this embodiment as a solid line spanning the image displayed on the electronic viewfinder. In other embodiments, the reference line may be dotted, dashed, or otherwise broken. The reference line need not span the entire displayed image and instead, in other embodiments, may only span a portion of the image or may be comprised of two short lines at directly opposing sides of the image, the lines extending only a short distance into the image. The reference line 30 may be of any desired width and color, and in one embodiment, may be semi-transparent such that the underlying image is visible therethrough. A wide, solid line, spanning the entire image may be desirable to make the reference line easier to see. However, such a line covers more of the image than a thin, dashed, or semi-transparent reference line, and, as such, may make it more difficult to align a feature in the image with the reference line. A dark reference line may be advantageous when the reference line is positioned over a bright portion of an image; however, a white, yellow, or other bright line may be preferred when the reference line is positioned over a dark area of the image. In an exemplary embodiment, the line type, color, transparency, and/or width are at least somewhat adjustable by the user. The user may be able to select at least some of the line characteristics using any number of user input means without departing from the present invention. For example, the user could use a menu system, designated keys, or a single key that toggles through several choices of reference lines and/or the characteristics of the reference line.

In one embodiment, the reference line is displayed anytime the user is taking a picture. In another embodiment, the reference line can be turned on or off by the user. Such an on/off feature may be preferable since the user may get distracted by the reference line when the user does not need the reference line. Although the system of embodiments of the present invention could be configured to use any user input device to adjust the reference line, if the system is incorporated into an existing electronic device, such as a mobile telephone, the system could be configured to use the keys or user input system that are already used by such devices. In such a situation, the electronic device, such as a mobile phone, may have different user-selectable modes that change the functions of device. For example, the user could change the phone from telephone mode to camera mode, in which case the phone's display would automatically become a viewfinder for the camera module, and the functions assigned certain keys would change to allow the user to take a picture, adjust the reference lines, etc., by actuating respective keys.

In another embodiment, the camera-equipped electronic device comprises at least two picture taking modes wherein one mode displays a reference line, and another mode does not display a reference line, or displays a different reference line. For example, the camera may comprise a “landscape” or a “panoramic” mode designed to activate all of the features of the camera that may be advantageous when taking pictures of landscapes. One such feature that may be activated in this mode could be a horizontal reference line, since many landscapes will involve a horizon or other features that the user intends to be parallel to a border of the image.

In an exemplary embodiment of the present invention, the position of the reference line relative to the electronic viewfinder is alterable by the user. FIG. 4 depicts the same display view of FIG. 3; however the horizontal reference line 30 in FIG. 4 has been moved closer to the horizon 12. As can be seen by comparing FIGS. 3 and 4, moving the horizontal reference line closer to the object or feature in the image that the user desires to be “horizontal” makes it easier to determine if the image is in fact tilted and how much the image is tilted. The position of the reference line may be altered by the user using any type of user input system. Preferably, the user input device used to move the reference line is a key, button, switch, joystick, voice recognition system, touch screen, or other user input device that already exists on the electronic device in which the system is embodied. For example, in one embodiment of the present invention where a camera-equipped mobile telephone has a directional key, the position of the reference line can be altered using the directional key when the phone is in an image capture mode and the reference line is displayed. In another embodiment, the scroll key of a PDA could be used to adjust a horizontal reference line up and down while keeping the line parallel to the image and/or display borders.

In one embodiment, where the image comprises parallel rows of pixels and where the reference line is comprised of a row of pixels, a computer program stored in the memory system instructs the processor in response to user input provided, for example, by a user input device to move the horizontal line up or down by shifting the line from one row of pixels to a row of pixels above or below the current row of pixels.

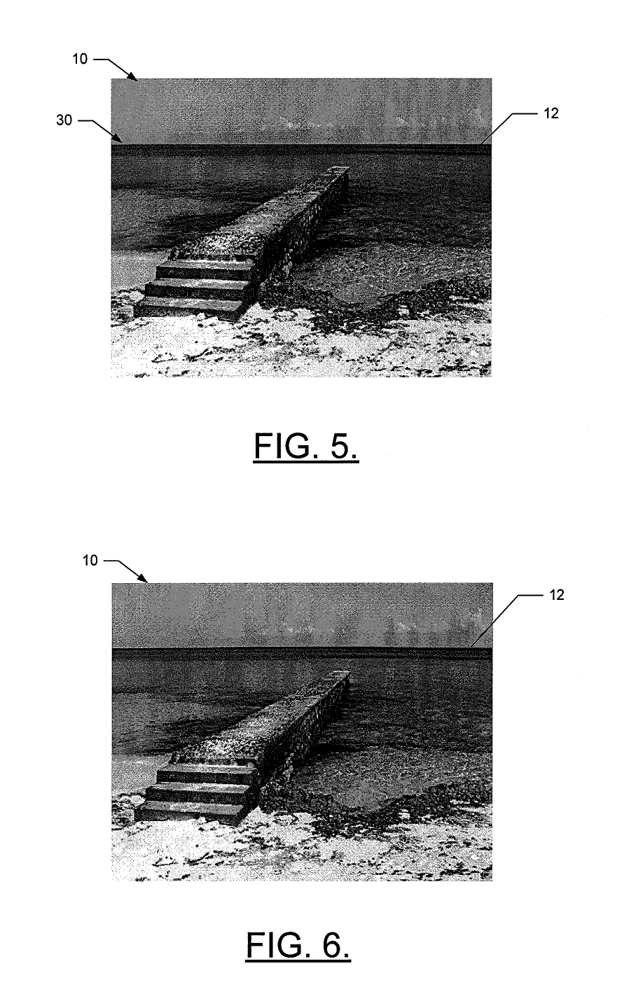

Once the user has positioned the horizontal reference line close to or in general alignment with the horizontal feature in the image, the user then rotates or otherwise repositions the image capturing means so that the feature in the image lines up with or is parallel to the reference line. FIG. 5 shows the display view of FIGS. 3 and 4 where the image capturing device has been rotated to where the horizon 12 lines up with the reference line 30. The image capturing device could be rotated by various systems or methods. For example, in a camera-equipped mobile telephone, a conventional film/digital camera, or other handheld camera-equipped electronic device comprising both an electronic viewfinder and an image capturing device, the image capturing device may be adjusted by simply rotating the entire phone, camera, or electronic device. Alternatively, such devices, or other electronic devices, may be configured so that the image capturing device moves at least in some ways independent of the other parts of the electronic device. Such a system may, in some situations, make it easier for the user to adjust the orientation of the image capturing device. For example, in one embodiment, rotation of the image capturing device may be electronic and capable of being finely adjusted using a user input device, such as a rocker switch. Such a system may be useful if the electronic device is a conventional camera and is positioned on a tripod. Rather than adjusting the tripod legs so that the camera is exactly horizontal, the image capturing device could be rotated relative to the base of the camera and finely adjusted until a horizontal feature of the image lined up with the reference line 30.

In other embodiments and other devices, the image capturing device may be rotated using a remote control. The remote control could be separate from the image capturing means and the electronic viewfinder. In one embodiment, the image capturing device may be located elsewhere on a network, such as a webcam, and be accessible by an internet-equipped electronic device, such as cell phone or PDA. The electronic display of the electronic device could be used as the electronic viewfinder for the webcam, and the keys on the electronic device could be used as a remote control for controlling the position of the webcam.

In still other embodiments, the image captured by the image capturing device could be rotated by a software application. For example, if the image sensor in a digital camera sensed a larger image area than the standard recorded image, or if, for example, the image sensor sensed a circular image and then automatically cropped the image to fit the standard picture size and shape, then the software could adjust where the image was cropped in order to effectively “rotate the image” with respect to the image borders. The user could then use the reference line as a guide when instructing the software to rotate the image which, in turn, defines the manner in which the image is cropped.

FIG. 6 shows the final recorded image after the user has used the reference line to correctly re-position the camera. The horizon 12 is now generally parallel to the top and bottom image borders and, as a result, appears horizontal and is more aesthetically pleasing. As can be seen, the recorded image does include the reference line 30.

Although the above descriptions and figures generally refer to a horizontal reference line, embodiments of the present invention are not limited to such an embodiment. One exemplary embodiment of the present invention is configured to display a reference line that is horizontal; however, other embodiments of the present invention can be configured to provide other types of reference lines on an electronic viewfinder. For example, the reference line may be a vertical reference line that a user can use to line up with features of an image that are intended to appear vertical. Like the horizontal reference line, the “vertical” reference line may not in fact be truly vertical, but instead may be a line that is parallel to the image borders and/or the display borders so that feature in the resulting image would appear vertical. A vertical reference line may be useful when taking pictures of city skylines, buildings, towers, walls in a room, or any feature that is intended to appear vertical in the final image. In one embodiment of the invention, the user can toggle between or otherwise select and deselect a horizontal reference line and a vertical reference line. In another embodiment, two or more reference lines can be displayed at the same time. In yet another embodiment, two or more lines may be displayed that move in tandem and/or are displayed parallel to each other.

In other embodiments of the present invention, the user may be able to select reference lines displayed at various angles or the user may be able to input a desired angle that the user wants the reference line to be displayed at, relative to the viewfinder. Reference lines that are not parallel to the image borders may be useful many purposes. For example, suppose a user desires to display pictures on a wall in a diamond shape but still desires that the horizontal or vertical features in the image be horizontal or vertical, respectively, when displayed. The user could then select a reference line that is displayed on the viewfinder at a 45° angle to the image borders and then rotate the camera to line up the horizontal or vertical features in the image with the reference line. In this way, the horizontal or vertical features will be horizontal and vertical when the image is displayed on the wall with the picture itself mounted at a 45° angle.

User-adjustable reference lines could be used for many other functions. For example, if a user is taking multiple still pictures of the same basic image and then desires to overlay the images or put the images in a flip book to show movement of some objects in an image, the user could use the reference lines to help position the camera in the same place for each image. For example, if the user is taking pictures of a building, the user could position reference lines around the building in the first image. In one embodiment of the present invention, the reference lines may stay in the same location after an image is taken. Thus, the user could then use the same reference lines positioned in the first image around to building in order to help the user position the building in the same location in the image when taking a second image.

In another example, the reference lines might be useful if the user desires to take multiple pictures and stitch them together. For example, a user standing on a boat in the ocean may desire to take a 360° picture. Using an embodiment of the present invention, the user could position a horizontal reference line at the horizon and take a first image. The user could then rotate his or her body to take a second image of another view. When taking the second image, the user could now align the horizon with the reference line from the first image. The user could then repeat the process until the user has images covering a 360° view around the user. Using the reference lines in this way, even if the boat is rocking, the user can more easily capture images where at least the horizons will generally be aligned when each image is displayed side by side, without the use of post-processing software and without having to crop the image. Similarly, the reference line(s) of the present invention may also be advantageous when recording video with a handheld video camera by helping the user keep an object or feature in the same position in the image.

As described above, in one embodiment, the reference lines may remain in the same altered state after the user alters the reference line and captures an image. In another embodiment, the reference line may reset to the center, top, or bottom, of the display, or some other default position and orientation following the capture of an image.

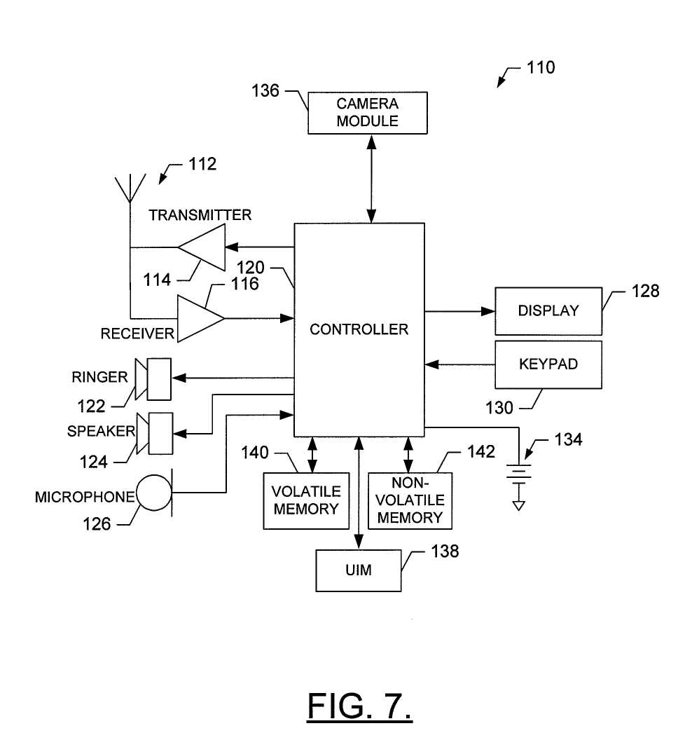

As mentioned above, an exemplary embodiment of the present invention involves incorporating the system and method into a mobile communication terminal, such as a mobile telephone. FIG. 7 illustrates a block diagram of a mobile terminal 110 that would benefit from the present invention. It should be understood, however, that a mobile telephone as illustrated and hereinafter described is merely illustrative of one type of mobile terminal that would benefit from embodiments of the present invention and, therefore, should not be taken to limit the scope of the present invention. While several embodiments of the mobile terminal 110 are illustrated and will be hereinafter described for purposes of example, other types of mobile terminals, such as portable digital assistants (PDAs), pagers, mobile televisions, laptop computers and other types of voice and text communications systems, can readily employ embodiments of the present invention. Furthermore, devices that are not mobile may also readily employ embodiments of the present invention.

In addition, while several embodiments of the method are performed or used by a mobile terminal 110, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 110 includes an antenna 112 in operable communication with a transmitter 114 and a receiver 116. The mobile terminal 110 further includes a processor comprising a controller 120 or other processing element that provides signals to and receives signals from the transmitter 114 and receiver 116, respectively. The signals include signaling information in accordance with the air interface standard of the applicable cellular system, and also user speech and/or user generated data. In this regard, the mobile terminal 110 is capable of operating with one or more air interface standards, communication protocols, modulation types, and access types. By way of illustration, the mobile terminal 110 is capable of operating in accordance with any of a number of first, second and/or third-generation communication protocols or the like. For example, the mobile terminal 110 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 120 includes circuitry required for implementing audio and logic functions of the mobile terminal 110. For example, the controller 120 may be comprised of a digital signal processor device, a microprocessor device, and various analog to digital converters, digital to analog converters, and other support circuits. Control and signal processing functions of the mobile terminal 110 are allocated between these devices according to their respective capabilities. The controller 120 thus may also include the functionality to convolutionally encode and interleave message and data prior to modulation and transmission. The controller 120 can additionally include an internal voice coder, and may include an internal data modem. Further, the controller 120 may include functionality to operate one or more software programs, which may be stored in memory. For example, the controller 120 may be capable of operating a connectivity program, such as a conventional Web browser. The connectivity program may then allow the mobile terminal 110 to transmit and receive Web content, such as location-based content, according to a Wireless Application Protocol (WAP), for example.

The mobile terminal 110 also comprises a user interface including an output system, such as an earphone or speaker 124, a ringer 122, and a display device 128, and a user input system, such as a microphone 126 and a keypad 130, all of which are coupled to the controller 120. The user input system, which allows the mobile terminal 110 to receive data, may include any of a number of devices allowing the mobile terminal 110 to receive data, such as a keypad 130, a touch display (not shown) or other input device. In embodiments including the keypad 130, the keypad 130 may include the conventional numeric (0-9) and related keys (#, *), and other keys used for operating the mobile terminal 110. Alternatively, the keypad 130 may include a conventional QWERTY keypad. The mobile terminal 110 further includes a battery 134, such as a vibrating battery pack, for powering various circuits that are required to operate the mobile terminal 110, as well as optionally providing mechanical vibration as a detectable output.

In an exemplary embodiment, the mobile terminal 110 includes an image capturing system comprising a camera module 136 in communication with the controller 120. The camera module 136 may be any means for capturing an image for storage, display or transmission. For example, the camera module 136 may include a digital camera capable of forming a digital image file from a captured image. As such, the camera module 136 includes all hardware, such as a lens or other optical device, and software necessary for creating a digital image file from a captured image. Alternatively, the camera module 136 may include only the hardware needed to view an image, while a memory device of the mobile terminal 110 stores instructions for execution by the controller 120 in the form of software necessary to create a digital image file from a captured image. In an exemplary embodiment, the camera module 136 may further include a processing element such as a co-processor which assists the controller 120 in processing image data and an encoder and/or decoder for compressing and/or decompressing image data. The encoder and/or decoder may encode and/or decode according to a JPEG standard format.

The mobile terminal 110 further includes a memory device. The memory device may further comprise a user identity module (UIM) 138. The UIM 138 is typically a memory device having a processor built in. The UIM 138 may include, for example, a subscriber identity module (SIM), a universal integrated circuit card (UICC), a universal subscriber identity module (USIM), a removable user identity module (R-UIM), etc. The UIM 138 typically stores information elements related to a mobile subscriber. In addition to the UIM 138, the memory device may be equipped with volatile memory 140, such as volatile Random Access Memory (RAM) including a cache area for the temporary storage of data. The memory device may also include other non-volatile memory 142, which can be embedded and/or may be removable. The non-volatile memory 142 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 110 to implement the functions of the mobile terminal 110. For example, the memories can include an identifier, such as an international mobile equipment identification (IMEI) code, capable of uniquely identifying the mobile terminal 110.

In one embodiment of the present invention, where the system and method of embodiments of the present invention include the mobile terminal 110 of FIG. 7, controller 120 could be configured to execute the software stored in the terminal's memory, wherein the software is configured to instruct the terminal to display reference lines on the viewfinder of the camera module. The display device 128 could be configured to operate as an electronic viewfinder for the camera module 136. As such, the display device 128 could be configured to display a reference line. Keypad 130 could be configured to allow the user to turn the reference line on or off. The keypad 130 could also be configured to allow the user to alter the reference line. Altering the reference line could include altering the line type, line weight, line color, transparency of the line, position of the line, angle of the line, etc. Based on user input provided via the keypad or otherwise, the processor, operating under control of the software, can appropriately display, alter, and/or reposition a reference line. In one embodiment, the microphone 126 could be used with voice recognition software stored in the memory and operated by the controller 120.

According to one aspect of the present invention, all or a portion of the system of embodiments of the present invention generally operates under control of a computer program product. The computer program product for performing the methods of embodiments of the present invention includes a computer-readable storage medium, such as the non-volatile storage medium 142 of FIG. 7, and computer-readable program code portions, such as a series of computer instructions, embodied in the computer-readable storage medium.

In this regard, the computer program instructions may be loaded onto a computer or other programmable apparatus to produce a machine, such that the instructions which execute on the computer or other programmable apparatus create means for implementing the functions described above in conjunction with the display of a reference line. These computer program instructions may also be stored in a computer-readable memory that can direct a computer or other programmable apparatus to function in a particular manner, such that the instructions stored in the computer-readable memory produce an article of manufacture including instruction means which implement the function described above in conjunction with the display of a reference line. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described above in conjunction with the display of a reference line.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
an image capturing device configured to capture an image;
a display for viewing a representation of the image; and
a processor configured to present a reference line on the display along with the representation of the image; wherein the processor is further configured to be responsive to user input in order to alter a position of the reference line with respect to the display.

2. The system of claim 1, wherein the image capturing device, the display and the processor are embodied in a mobile telephone or digital camera.

3. The system of claim 1, wherein the image capturing device is configured to record a video image or a still image.

4. The system of claim 1, wherein the display comprises a plurality of pixels, organized in generally parallel rows, and wherein the processor is configured to illuminate at least one row of pixels to represent the reference line.

5. The system of claim 1, wherein the processor is configured to present a horizontal reference line or a vertical reference line.

6. The system of claim 1, wherein the border of the image captured by the image capturing device comprises a straight portion, and wherein the processor is configured to present a reference line that is parallel to the straight portion of the border of the image.

7. The system of claim 1, further comprising a user input device configured to allow a user to selectively activate and deactivate presentation of the reference line.

8. The system of claim 1, further comprising a user input device configured to allow a user to alter an angle of the reference line with respect to the display.

9. The system of claim 1, further comprising a user input device configured to allow a user to alter a location of the reference line on the display.

10. The system of claim 9, wherein the user input device comprises a directional key for moving the reference line relative to the display, and wherein the reference line moves in a direction perpendicular to itself so that the reference line maintains a consistent angle relative to the display as the reference line is moved.

11. The system of claim 1, wherein the processor is configured to present a solid line extending across the display as the reference line.

12. The system of claim 1, wherein the processor is configured to present a reference line comprised of a dashed line.

13. The system of claim 1, wherein the processor is configured to present a reference line comprised of a first line segment extending from a first side of the display only partially across the display, and a second line segment extending from a second opposing side of the display only partially across the display, wherein the first and the second line segments are linearly aligned with each other.

14. The system of claim 1, wherein the processor is configured to present the reference line as a semi-transparent line displayed over the representation of the image.

15. The system of claim 1, further comprising a user input device configured to allow a user to alter characteristics of the reference line.

16. The system of claim 1, wherein the reference line is at a first altered position when a first image is recorded, and wherein the processor is configured to initially set the position of the reference line to the first altered position in preparation for recording a second image.

17. A method of taking a picture comprising:
providing an electronic device comprising a camera, wherein the camera comprises an electronic viewfinder for viewing a representation of an image to be recorded by the camera, and wherein the electronic viewfinder is configured to display a reference line overlaying the representation of the image;
altering the position or orientation of the reference line relative to the electronic viewfinder;
altering the position or orientation of the camera so that a feature in the representation of the image is aligned with the reference line; and
recording the image.

18. The method of claim 17, wherein the reference line has a predefined orientation, the altering step further comprising:
identifying an object or feature in the image to be recorded having the same predefined orientation;
moving the reference line relative to the viewfinder so that the reference line is positioned closer to the identified object or feature; and
altering the position or orientation of the camera so that the identified object or feature is generally parallel to the reference line.

19. The method of claim 17, the altering step further comprising:
moving the reference line to a first altered position on the viewfinder proximate to an object or feature in a first image and recording the first image; and
positioning the camera so that the same object or feature is positioned proximate the reference line in the first altered position, and recording a second image.

20. A computer program product for facilitating positioning of a camera, wherein the camera is operatively coupled to an electronic display configured to be used as a viewfinder for the camera, the computer program product comprising at least one computer-readable storage medium having computer-readable program code portions stored therein, the computer-readable program code portions comprising:
a first executable portion for displaying a reference line on the electronic viewfinder; and
a second executable for altering the position or the orientation of the reference line relative to the electronic viewfinder in response to instructions received from the user.

21. The computer program product of claim 20, wherein the electronic viewfinder displays images as generally parallel rows of pixels, and wherein the first executable portion is configured to instruct the electronic viewfinder to display the reference line with one or more rows of pixels.

22. The computer program product of claim 20, wherein the computer-readable program code portions further comprises:
a third executable for altering the color, transparency, line type, or line width of the reference line in response to instructions received from the user.

23. An apparatus comprising:
a display for viewing an image; and
a processing element configured to present a reference line on the display along with the image; wherein the processor is further configured to be responsive to user input in order to alter a position of the reference line with respect to the display.

24. The apparatus of claim 23, wherein the border of the display comprises a straight portion, and wherein the processing element is configured to present a reference line that is parallel to the straight portion of the border of the display.

25. The apparatus of claim 23, wherein the processor is further configured to be responsive to user input in order to alter a characteristic of the reference line.

26. The apparatus of claim 23, further comprising an image capturing device for capturing the image viewed on the display.
